(19) United States
(12) Patent Application Publication
(10) Pub. No.: US 2009/0310252 A1
(43) Pub. Date: Dec. 17, 2009

(54) INFORMATION STORING APPARATUS

(75) Inventor: Keishi Shimizu, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/395,399

(22) Filed: Feb. 27, 2009

(30) Foreign Application Priority Data
Jun. 12, 2008 (JP) 2008-154699

(51) Int. Cl. G11B 21/04

(52) U.S. Cl. 360/81

(57) ABSTRACT

A disclosed information storing apparatus includes a rotatably-mounted memory medium; a carriage arm having a head at its tip; a flow rectifying wall configured to lead a partial airflow of a rotational airflow flowing in a rotation direction of the memory medium and rectify the partial airflow, and including an inflow opening from which the partial airflow flows into the inner path of the flow rectifying wall and an outflow opening from which the partial airflow having passed through the inner path flows out; and a circulation filter. The inflow opening and outflow opening are disposed on an upstream side and a downstream side, respectively, of the rotational airflow with respect to the carriage arm. The circulation filter is disposed in such a position that the led partial airflow flows into the circulation filter in a direction opposite to the flow direction of the rotational airflow.

### CROSS-REFERENCE TO RELATED APPLICATIONS

This application is based upon and claims the benefit of priority of Japanese Patent Application 2008-154699, filed on Jun. 12, 2008, the entire contents of which are hereby incorporated herein by reference.

### FIELD

The present disclosure is directed to an information storing apparatus, and in particular to an information storing apparatus including a rotatably-mounted memory medium and a circulation filter.

### BACKGROUND

Hard disk drives are examples of information storing apparatuses including a rotatably-mounted memory medium and a circulation filter.

An important issue related to hard disk devices has been control of dust generated inside the devices due to the low flying height of the magnetic head, which has been introduced in association with high recording density increases of magnetic disks. A technology known as such dust control is, for example, to provide in the devices a circulation filter for trapping dust. As for an installation position of the circulation filter, it has been proposed to install the circulation filter at a corner section of a device housing, or to provide an airflow path in an empty space on a side on which a voice coil motor is disposed and install the circulation filter in the airflow path.

[Patent Document 1] Japanese Laid-open Patent Application Publication No. H08-129871
[Patent Document 2] Japanese Laid-open Patent Application Publication No. H11-73756

### [Patent Document 3] Japanese Laid-open Patent Application Publication No. 2007-12183

### [Patent Document 4] Japanese Laid-open Patent Application Publication No. 2007-35218

### [Patent Document 5] Japanese Laid-open Patent Application Publication No. 2004-171713

### [Patent Document 6] Japanese Laid-open Patent Application Publication No. 2005-71581

### SUMMARY

One aspect of the present disclosure is an information storing apparatus including a rotatably-mounted memory medium; a carriage arm having, at its tip, a head configured to perform at least one of reproduction of information recorded on the memory medium and writing of information on the memory medium, the carriage arm being movable so as to move the head to a predetermined position relative to the memory medium; a flow rectifying wall disposed along the outer circumference of the memory medium, configured to lead a partial airflow which is part of a rotational airflow flowing in the rotation direction of the memory medium and rectify the partial airflow, and including an inflow opening from which the partial airflow flows into the inner path of the flow rectifying wall and an outflow opening from which the partial airflow having passed through the inner path of the flow rectifying wall flows out; and a circulation filter. The inflow opening is disposed on the upstream side of the rotational airflow with respect to the carriage arm, and the outflow opening is disposed on the downstream side of the rotational airflow with respect to the carriage arm. The circulation filter is disposed in such a position that the partial airflow led into the inner path of the flow rectifying wall flows into the circulation filter in a direction opposite to the flow direction of the rotational airflow.

### BRIEF DESCRIPTION OF DRAWINGS

FIGS. 1A and 1B are a plan view and a front view, respectively, showing an overall structure of a hard disk device according to a first embodiment;

FIG. 2 shows a part of the hard disk device of FIG. 1 and is a plan view around a magnetic disk;

FIG. 3 shows a part of the hard disk device of FIG. 1 and is a plan view around a circulation filter airflow path;

FIGS. 4A through 4D illustrate operational effects of the hard disk device according to the first embodiment compared to a comparative example;

FIG. 5 shows a part of the hard disk device of FIG. 1 and is an enlarged perspective view around the circulation filter airflow path;

FIG. 6 shows a part of the hard disk device according to a second embodiment and an enlarged plan view around a circulation filter airflow path;

FIGS. 7A through 7D illustrate operational effects of hard disk devices according to the comparative example, the first embodiment, and first and second modifications in comparison to each other; and

FIG. 8 is a diagram for explaining terms used in the present disclosure.

### DESCRIPTION OF EMBODIMENT

In the case of providing the circulation filter in a corner section of the device housing, enough pressure difference may not be created between the inflow side and the outflow side of the circulation filter. As a result, a sufficient flow rate passing through the circulation filter cannot be ensured, and accordingly, sufficient dust trapping efficiency may not be obtained.

In the case of providing an airflow path on the voice coil motor side and installing the circulation filter within the airflow path, the following problem may occur. A load/unload mechanism, a latch mechanism and the like are provided around the voice coil motor. Therefore, the empty space becomes limited, and it seems difficult to provide an airflow path enabling the circulation filter to achieve sufficient duct trapping efficiency.

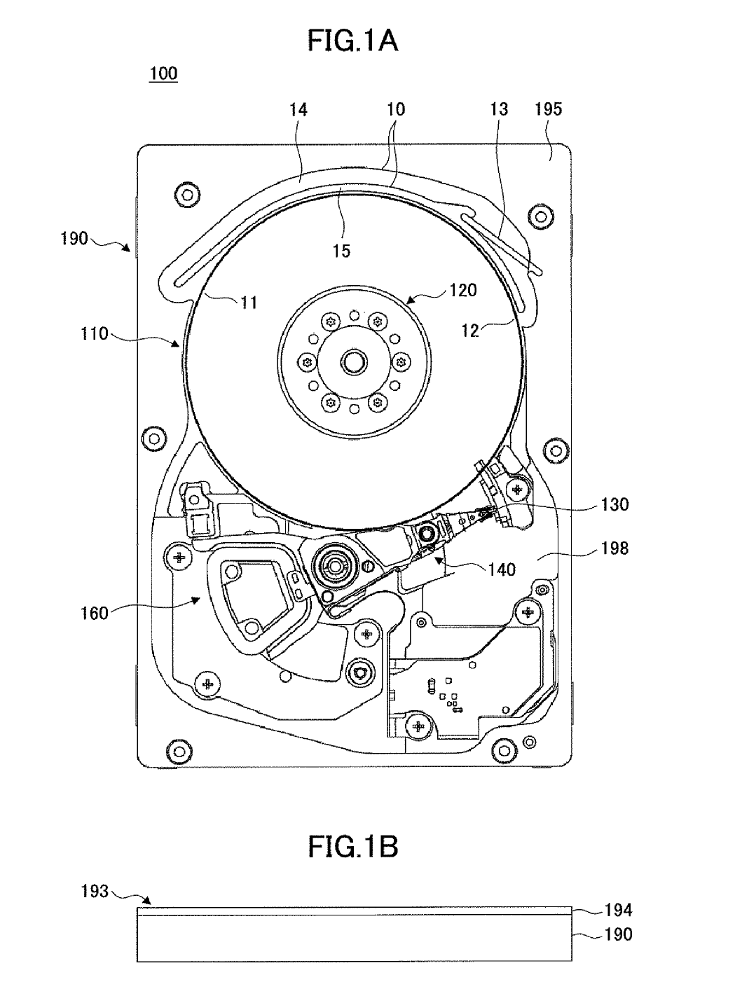

FIG. 1A is a plan view showing the internal structure of a hard disk device according to the first embodiment. FIG. 1B is a front view of the hard disk device.

As illustrated in FIG. 1B, a hard disk device 100 includes a housing 193 which has a base 190 and a cover 194 placed over the base 190. As illustrated in FIG. 1A, the base 190 includes an outer wall portion 195 and a housing recess portion 198 surrounded by the outer wall portion 195. Components described below are housed in the housing recess portion 198.

The housing recess portion 198 houses a magnetic disk 110, which functions as an information memory medium, and a spindle motor 120 for driving the magnetic disk 110 to rotate. The housing recess portion 198 also houses a carriage arm 140 having a magnetic head 130 at its tip. The magnetic head 130 writes information on the magnetic disk 110 and reproduces information recorded on the magnetic disk 110. On the carriage arm 140, two magnetic heads 130 are mounted with respect to each magnetic disk 110. One of the magnetic heads 130 is provided for a front side of the magnetic disk 110, and the other one is provided for a back side of the magnetic disk 110. The housing recess portion 198 further houses a voice coil motor 160 which moves the magnetic heads 130 to arbitrary cylinders of the magnetic disk 110 by driving the carriage arm 140 to rotate.

One magnetic disk 110 may be provided, or two or more magnetic disks 110 may be provided. In the case where two or more magnetic disks 110 are provided, all the magnetic disks 110 are mounted on a single, common spindle motor 120. The magnetic disks 110 are mounted on the spindle motor 120 in such a manner as to align at specified intervals in a direction of the rotational axis of the magnetic disks 110 perpendicular to the page of FIG. 1. In the case where two or more magnetic disks 110 are mounted, the term “rotational airflow over the magnetic disk 110” below should be read as “rotational airflows over the magnetic disks 110 or rotational airflows between the magnetic disks 110”.

For the hard disk device 100, the structure of a publicly-known hard disk device (that is, a so-called HDD) may be employed, except for a circulation filter 13 to be described below. Accordingly, a detailed description of the structure of the hard disk device 100 is omitted.

The hard disk device 100 includes the circulation filter 13 for removing dust inside the housing 193 and flow rectifying walls 10 for guiding to the circulation filter 13 air from which dust needs to be removed. The flow rectifying walls 10 provide two wall surfaces opposing each other and define a circulation filter airflow path 14 extending in the front and back sides of the circulation filter 13. The circulation filter airflow path 14 has an inflow opening 11 for taking in an airflow caused by the rotation of the magnetic disk 110. The circulation filter airflow path 14 also has an outflow opening 12 for discharging air from which dust has been removed by the circulation filter 13. The airflow caused by the rotation of the magnetic disk 110 is formed over the magnetic disk 110 and rotates in the same direction as the rotation direction of the magnetic disk 110. This airflow is referred to as “rotational airflow”.

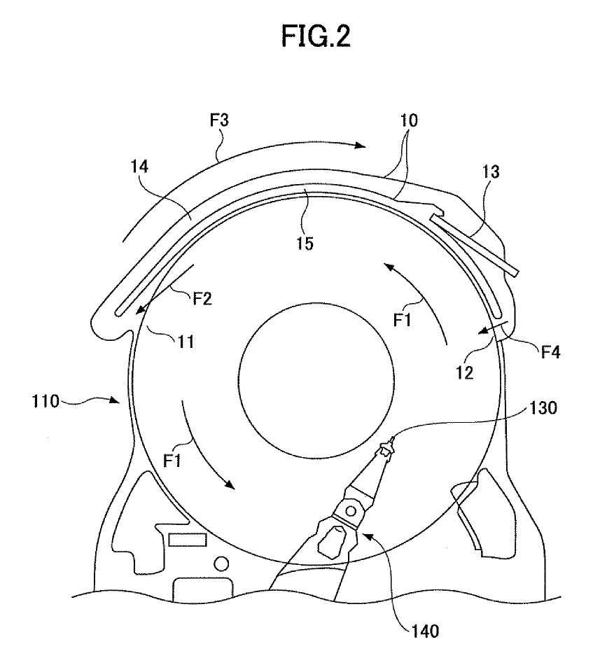

According to the first embodiment, the circulation filter airflow path 14 is provided at a position opposing the voice coil motor 160 across the magnetic disk 110, as described above. That is, the circulation filter airflow path 14 is provided at a position which has no influence on the disposition of components around the voice coil motor 160. Also, for the reason mentioned below, the circulation filter airflow path 14 having such a structure and functioning as an airflow path for guiding the rotational airflow to the circulation filter 13 effectively improves the dust trapping efficiency of the circulation filter 13. The magnetic disk 110 on the hard disk device 100 rotates in the counterclockwise direction in FIG. 1, as shown by arrows F1 in FIG. 2.

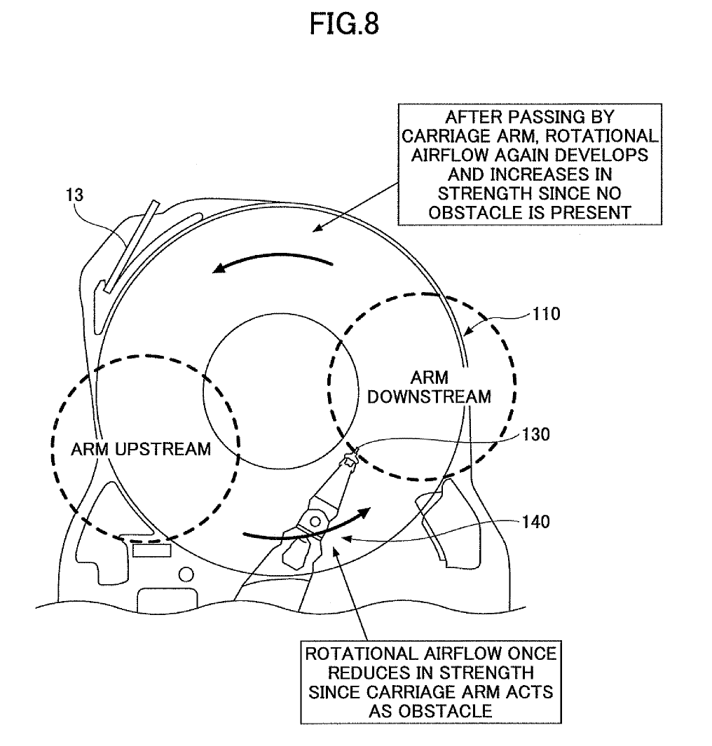

In the first embodiment, the inflow opening 11 is provided at a position facing the circumferential plane of the outer edge of the magnetic disk 110 and located on the upstream side of the rotational airflow with respect to the carriage arm 140. The upstream side of the rotational airflow in the counterclockwise direction caused by the rotation of the magnetic disk 110 is hereinafter referred to as “arm upstream”. The location of the arm upstream is described later with reference to FIG. 8. An airflow split from the rotational airflow circulating over the magnetic disk 110 flows into the circulation filter airflow path 14 from the inflow opening 11.

The outflow opening 12 is provided at a position facing the circumferential plane of the outer edge of the magnetic disk 110 and located on the downstream side of the rotational airflow with respect to the carriage arm 140. The downstream side of the rotational airflow in relation to the carriage arm 140 is hereinafter referred to as “arm downstream”. The location of the arm downstream is also described later with reference to FIG. 8. According to this structure, the airflow inside the circulation filter airflow path 14 flows in a direction opposite to the rotational airflow caused by the rotation of the magnetic disk 110 and flowing in the counterclockwise direction. That is, the airflow inside the circulation filter airflow path 14 flows in the clockwise direction in FIG. 1.

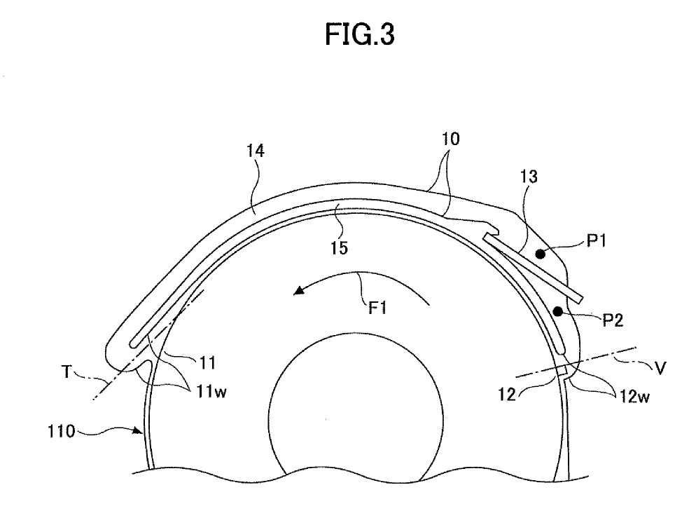

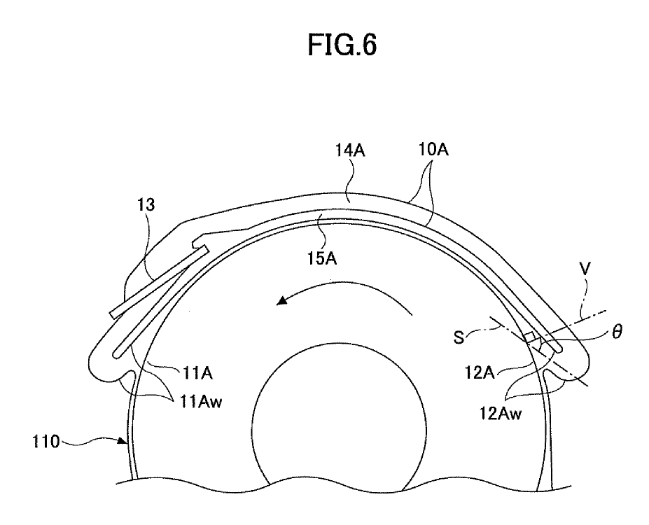

According to the first embodiment, the outflow opening 12 has an airflow path following a direction perpendicular to the direction of the rotational airflow. On the other hand, according to the second embodiment described below with reference to FIG. 6, the outflow opening has an airflow path following a direction that allows the airflow to be discharged in a direction along the rotational airflow flowing in the counterclockwise direction. Therefore, the direction of the airflow path of the outflow opening according to the second embodiment inclines from the perpendicular direction so as to follow the direction of the rotational airflow. These airflow paths of the outflow opening are described below in detail with reference to FIGS. 3, 5 and 6.

FIG. 2 is an explanatory diagram of a passage of the airflow according to the first embodiment, and provides a schematic plan view showing a partial structure of FIG. 1, specifically the magnetic disk 110 and its surroundings.

As illustrated in FIG. 2, the rotational airflow is formed in the direction indicated by F1, and an airflow split from the rotational airflow flows into the circulation filter airflow path 14 from the inflow opening 11, following the direction indicated by F2. The inflow opening 11 has an airflow path following the direction of the tangent F2 to the curve of the outer edge of the magnetic disk 110. Accordingly, the airflow split from the rotational airflow over the magnetic disk 110 flows into the inflow opening 11. The air thus flowing into the circulation filter airflow path 14 follows the circulation filter flow path 14 as forming an airflow along the clockwise direction in FIG. 2, and travels toward the circulation filter 13. Subsequently, the air passes through the circulation filter 13, by which dust in the air is trapped. The air having passed through the circulation filter 13 flows out from the outflow opening 12 toward an open space over the magnetic disk 110. The air flowing out to the open space over the magnetic disk 110 joins the rotational airflow.

Thus, according to the hard disk device 100 of the first embodiment 1, an airflow circulating in the reverse direction (F3 in FIG. 2) relative to the rotational airflow caused by the rotation of the magnetic disk 110 is formed in the circulation filter airflow path 14. As a result, the hard disk device 100 of the first embodiment effectively improves the dust trapping efficiency of the circulation filter 13, compared to a structural example (hereinafter, referred to as “comparative example”) in which an airflow passing through the circulation filter flows in the same direction as the rotational airflow caused by the rotation of the magnetic disk. The reason is explained below.

The rotational airflow caused by the rotation of the magnetic disk 110 is interfered with by the carriage arm 140. Accordingly, the kinetic energy of the rotational airflow is small at the arm downstream. From the arm downstream toward the arm upstream in the counterclockwise direction in FIG. 2, the rotational airflow gradually develops due to the rotation of the magnetic disk 110, and therefore, the kinetic energy of the rotational airflow gradually increases. As a result, the kinetic energy reaches a maximum just before the carriage arm 140.

On the other hand, the comparative example employs the following structure. When the rotational airflow whose kinetic energy is reduced due to being interfered with by the carriage arm as described above has yet to be fully developed, an airflow split from the underdeveloped rotational airflow flows in the circulation filter. In order to take in the airflow split from the rotational airflow and pass it through the circulation filter, it is necessary to provide an airflow path with a measurable length extending on the front and back sides of the circulation filter 13, in view of the efficiency of the circulation filter. Accordingly, a relatively long distance needs to be provided between the inflow opening and the outflow opening. In addition, in the case of the comparative example, the inflow opening is positioned on the upper-stream side of the outflow opening. Furthermore, since it is difficult to secure an empty space around the voice coil motor, as described above, the circulation filter airflow path needs to be provided at a position opposing the voice coil motor across the magnetic disk.

Under the circumstances, in the comparative example, the inflow opening necessary to be on the upstream side of the outflow opening is inevitably disposed at a position on the upstream side of the rotational airflow. That is, within the passage of the rotational airflow extending in the counterclockwise direction from the carriage arm and going round a nearly full circle to return to the carriage arm, the inflow opening is disposed at a position shifted in the clockwise direction from the arm upstream toward the arm downstream by an amount corresponding to the length of the circulation filter airflow path. Accordingly, an airflow split from the rotational airflow having yet to be fully developed is taken into the circulation filter airflow path, as described above. As a result, the stagnation pressure on the inflow side of the circulation filter is reduced, whereby the efficiency of the circulation filter decreases.

On the other hand, according to the first embodiment, the airflow in the circulation filter airflow path 14 flows in the direction opposite to the direction of the rotational airflow formed over the magnetic disk 110, as described above. Therefore, the inflow opening 11 of the circulation filter airflow path 14 can be disposed at the arm upstream. As a result, it is possible to allow the rotational airflow whose energy has been lowered due to obstruction by the carriage arm 140 to sufficiently develop, and send an airflow split from the developed rotational airflow to the circulation filter airflow path 14. That is, within the passage in the counterclockwise direction from the arm downstream to the inflow opening 11, the rotational airflow gains kinetic energy and gradually develops over the magnetic disk 110 spinning at high speed. Subsequently, as the rotational airflow has sufficiently developed, an airflow is split from the rotational airflow and taken in from the inflow opening 11. As a result, it is possible to effectively increase the pressure difference between the front side and the back side of the circulation filter 13. In this manner, the flow rate through the circulation filter 13 is increased, whereby the dust trapping efficiency is improved.

Thus, according to the hard disk device 100 of the first embodiment, it is possible to provide the inflow opening 11 of the circulation filter airflow path 14 at a position, within the arm upstream, very close to the carriage arm 140. Also, it is possible to provide the outflow opening 12 of the circulation filter airflow path 14 at a position, within the arm downstream, very close to the carriage arm 140. After passing by the carriage arm 140, the rotational airflow over the magnetic disk 110 gradually develops in the passage extending in the counterclockwise direction and going around a nearly full circle to return to the carriage arm 140, as described above. Accordingly, the structure of the first embodiment achieves the following effect.

That is to say, air is brought into the circulation filter airflow path 14 at a location where the rotational airflow has sufficiently developed and gained high kinetic energy, and air having passed through the circulation filter 13 is discharged at a location where the rotational airflow has yet to be developed and has low kinetic energy. As a result, it is possible to effectively increase the pressure difference between the front side and the back side of the circulation filter 13, thereby effectively improving the dust trapping efficiency.

In the hard disk device 100 of the first embodiment, the inflow opening 11 preferably has a shape which allows air to flow in along the rotational airflow, as illustrated in FIG. 3. Such a shape enables the air to be taken in from the inflow opening 11 while maintaining the kinetic energy of the rotational airflow. Accordingly, it is possible to allow the air after being brought into and flowing through the circulation filter airflow path 14 and reaching the circulation filter 13 to have high kinetic energy. This results in an increase in the stagnation pressure at a position P1 before the circulation filter 13, which in turn leads to an increase in the flow rate through the circulation filter 13. Consequently, the circulation filter 13 has improved dust trapping efficiency.

In addition, it is necessary to prevent the rotational airflow over the magnetic disk 110 from flowing in from the outflow opening 12 and reaching a position P2 behind the circulation filter 13. If the rotational airflow over the magnetic disk 110 flows into the position P2, the pressure at the position P2 increases, and as a result, the pressure difference between the front side and the back side of the circulation filter 13 decreases. This reduces the flow rate through the circulation filter 13, thereby lowering the dust trapping efficiency of the circulation filter 13. In order to prevent such a situation, the output opening 12 preferably has a shape that prevents the rotational airflow over the magnetic disk 110 from flowing in. Accordingly, it is preferable that the outflow opening 12 have the following shape.

As shown in, for example, FIG. 3 according to the first embodiment, an airflow path following a direction V perpendicular to a tangent to the curve of the outer edge of the magnetic disk 110 is formed at the outflow opening 12. Alternatively, in the case of the second embodiment 2 described later with reference to FIG. 6, an airflow path following a direction S inclined from the perpendicular direction V is formed at an outflow opening 12A.

The above structures of the inflow opening 11 and the outflow opening 12 eliminate the need of separately providing over the magnetic disk 110 or between the magnetic disks 110 components, such as a flow rectifying plate and an inductive plate, used for guiding the rotational airflow over the magnetic disk 110 to the circulation filter airflow path 14. That is, by employing the above structures of the inflow opening 11 and the outflow opening 12, a circulating airflow in a direction opposite to the rotational airflow over the magnetic disk 110 is formed in the circulation filter airflow path 14. This results in an effective increase in the amount of the airflow split from the rotational airflow and brought into the circulation filter airflow path 14 for the filtering process performed by the circulation filter 13. As a result, it is unnecessary to provide components including a flow rectifying plate and an inductive plate, as described above, and an increase in the workload of the spindle motor 120 due to such components is never an issue with the hard disk device 100 of the first embodiment. Note that, in the structure of the first embodiment illustrated in, for example, FIG. 3, the circulation filter 13 is disposed at an angle relative to the circulation filter airflow path 14. This increases the area of the circulation filter 13 exposed to the circulation filter airflow path 14, thereby effectively increasing the flow rate through the circulation filter 13.

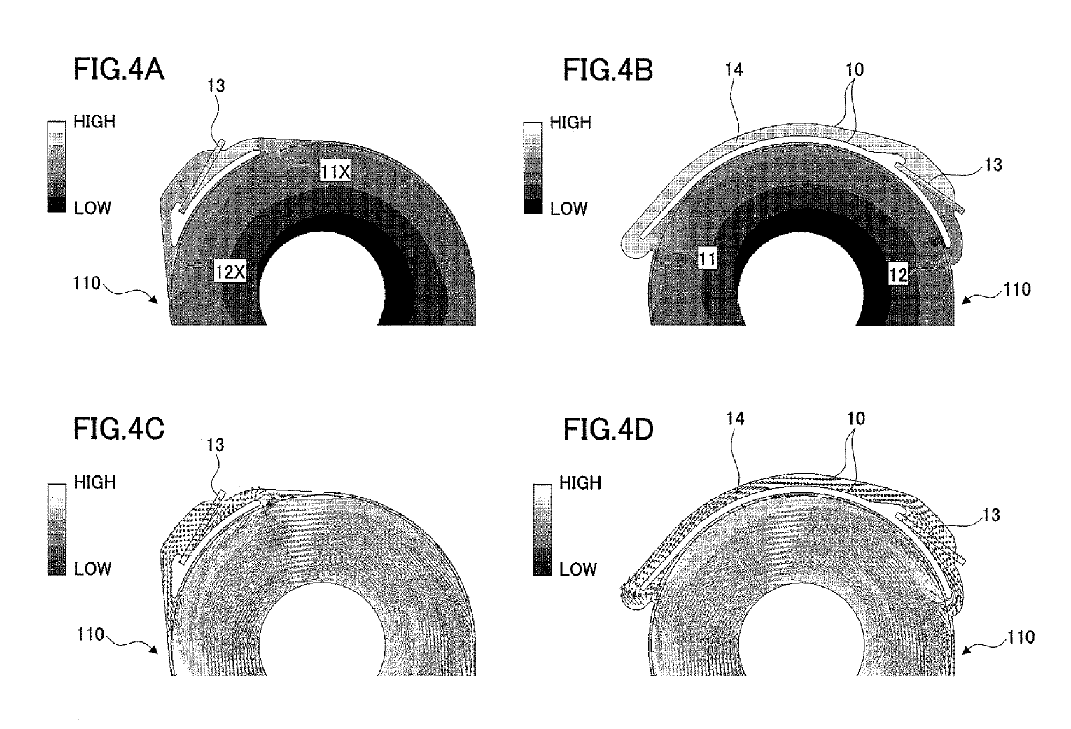

FIG. 4 shows results of a simulation using the comparative example and the first embodiment. Using a numerical fluid analysis, a comparative verification of the comparative example and the first embodiment is performed in which two magnetic disks 110 are used and a transverse plane between the planes of the two magnetic disks 110 is used as a calculation area. In the comparative verification, the efficiency of the circulation filter 13, the filter area and the boundary conditions are constant between the comparative example and the first embodiment.

With reference to static pressure distributions illustrated in FIGS. 4A and 4B, it is understood that the pressure difference between the front side and the back side of the circulation filter 13 is larger in the first embodiment of FIG. 4B compared to the comparative example of FIG. 4A, as described above. The simulation revealed that the first embodiment exhibits a better flow rate through the circulation filter 13 than the comparative example by 34%. Thus, it is ensured that the first embodiment has improved dust trapping efficiency of the circulation filter 13. FIGS. 4C and 4D show flow vectors obtained in the above simulation. In the case of the first embodiment of FIG. 4D, it is seen that a bypass circulating flow generated in the circulation filter airflow path 14 flows in a direction opposite to the rotational airflow over the magnetic disk 110. On the other hand, in the case of the comparative example of FIG. 4C, it is understood that a bypass circulating flow led to the circulation filter 13 flows in the same direction as the rotational airflow over the magnetic disk 110.

The following explains parameters of the above simulation. A transverse plane between the disk planes of the two magnetic disks 110 is used as a calculation area. The upper and lower cross sections between the magnetic disks 110, as the boundary conditions, are symmetrical to each other. The rotational speed of the circumferential plane of the magnetic disks 110 is 10000 rpm. A three-dimensional steady flow analysis is performed using the inner wall plane of the housing 193 as a fixed wall. Volume resistance of the circulation filter 13 is specified, and the cross-sectional area of the circulation filter 13 is constant in all cases of the analysis.

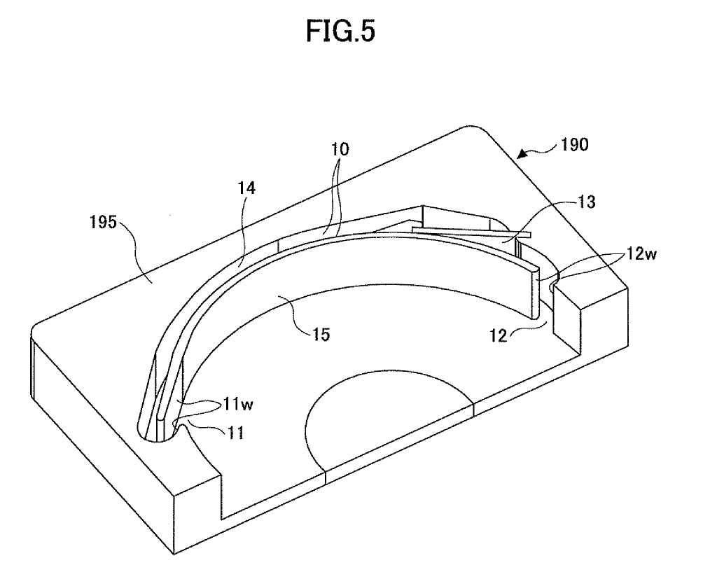

FIG. 5 is a perspective view for illustrating the shape of the circulation filter airflow path 14 defined by the flow rectifying walls 10 in the hard disk device 100 of the first embodiment. As depicted in FIGS. 5 and 1, the circulation filter airflow path 14 is formed by hollowing out a part of the outer wall portion 195 surrounding the magnetic disk 110. That is, a part of the outer wall portion 195 substantially opposing the voice coil motor 160 across the magnetic disk 110 is hollowed out along the curve of the outer edge of the magnetic disk 110, thereby forming the circulation filter airflow path 14. Thus, within the outer wall portion, a part facing the circumferential plane of the outer edge of the magnetic disk 110 is left as an inner wall portion 15. The height direction of the flow rectifying walls 10 defining the circulation filter airflow path 14 corresponds to the direction of the rotational axis of the magnetic disk 110.

The inflow opening 11 for guiding the rotational airflow over the magnetic disk 110 to the circulation filter airflow path 14 has an airflow path defined by inflow wall surfaces 11w. The inflow wall surfaces 11w extend in a direction T tangent to the curve of the outer edge of the magnetic disk 110 so that the airflow path of the inflow opening 11 extends along the direction T, as illustrated in FIG. 3. The tangent direction T corresponds to the direction F2 in which the airflow split from the rotational airflow flows into the circulation filter airflow path 14

After the inflow opening 11, the circulation filter airflow path 14 bends at a sharp angle to the right-handed side, and extends in a direction toward the circulation filter 13 along the clockwise direction F3 of FIG. 2. Accordingly, the airflow split from the rotational airflow and led into the circulation filter airflow path 14 from the inflow opening 11 is turned approximately 180 degrees, and passes through the circulation filter airflow path 14 along the direction F3 to head to the circulation filter 13. The circulation filter airflow path 14 between the turn and the near side of the circulation filter 13 extends along the curve of the outer edge of the magnetic disk 110. In front of the circulation filter 13, the circulation filter airflow path 14 forms a bulge outward, whereby the airflow turns 90 degrees to the right so as to flow into the circulation filter 13 in a substantially perpendicular direction.

On the back side of the circulation filter 13, the circulation filter airflow path 14 extends in the clockwise direction along the curve of the outer edge of the magnetic disk 110. Then, at the outflow opening 12, the circulation filter airflow path 14 turns approximately 90 degrees to the right. The outflow opening 12 has an airflow path in a direction F4 perpendicular to a tangent to the curve of the outer edge of the magnetic disk 110, i.e. in the direction V of FIG. 3. The airflow path of the outflow opening 12 is defined by outflow wall surfaces 12w opposing each other. The outflow wall surfaces 12w extend along the direction F4 (i.e. V) so as to define the airflow path.

FIG. 6 is a plan view for illustrating the structure of a hard disk device according to the second embodiment.

The hard disk device of the second embodiment has the same structure as that of the hard disk device 100 of the first embodiment; however, the shape of a circulation filter airflow path 14A is different from that of the circulation filter airflow path 14 of the first embodiment. The following describes only points different from the first embodiment.

A difference from the circulation filter airflow path 14 of the hard disk device 100 of the first embodiment illustrated in FIG. 3 is that the circulation filter 13 is disposed close to an inflow opening 11A in the circulation airflow path 14A of the hard disk device of the second embodiment. In addition, in the circulation airflow path 14A of the hard disk device of the second embodiment, the direction of the airflow path of an outflow opening 12A is different from that of the outflow opening 12. These differences are explained below.

The circulation filter airflow path 14A of the second embodiment is defined by flow rectifying walls 10A, and has an inner wall portion 15A. Similar to the flow rectifying walls 10 of the first embodiment, the height direction of the flow rectifying walls 10A corresponds to the direction of the rotational axis of the magnetic disk 110, and the flow rectifying walls 10A extend along the curve of the outer edge of the magnetic disk 110. Similar to the inflow opening 11 of the first embodiment, the inflow opening 11A of the second embodiment has an airflow path extending in a direction tangent to the curve of the outer edge of the magnetic disk 110. The airflow path is defined by inflow wall surfaces 11Aw. After the inflow opening 11A, the circulation filter airflow path 14A extends in the clockwise direction along the curve of the outer edge of the magnetic disk 110 and reaches the circulation filter 13. The circulation filter airflow path 14A forms a bulge on the back side of the circulation filter 13. After the circulation filter 13, the circulation filter airflow path 14A extends in the clockwise direction along the curve of the outer edge of the magnetic disk 110 and reaches the outflow opening 12A.

Thus, in the circulation filter airflow path, the circulation filter 13 may be disposed close to the outflow opening 12 as in the case of the first embodiment, or may be disposed close to the inflow opening 11A as in the case of the second embodiment. Alternatively, the circulation filter 13 may be disposed in the middle between the inflow and outflow openings. In any case, the inflow opening of the circulation filter airflow path is preferably provided, within the arm upstream, close to the carriage arm 140, as described above. Accordingly, it is possible to allow the rotational airflow over the magnetic disk 110 to sufficiently develop, and send an airflow split from the developed rotational airflow to the circulation filter airflow path. This results in an increase in the stagnation pressure at the inlet of the circulation filter 13, which in turn leads to an increase in the flow rate through the circulation filter 13. Consequently, the circulation filter 13 has improved dust trapping efficiency. In addition, the outflow opening of the circulation filter airflow path is preferably disposed, within the arm downstream, close to the carriage arm 140. Accordingly, the rotational airflow over the magnetic disk 110 has yet to be developed at a position where the air having passed through the circulation filter 13 is sent back to the space over the magnetic disk 110, and therefore, it is possible to prevent an increase in the outlet pressure of the circulation filter 13. This leads to an increase in the flow rate through the circulation filter 13, which in turn results in improved dust trapping efficiency of the circulation filter 13. Provided that these two conditions are satisfied, the position of the circulation filter 13 within the circulation filter airflow path is arbitrary. If the airflow in the circulation filter airflow path flows in a direction opposite to the rotational airflow, a certain degree of effect is obtained even if only one of the two conditions is met, as in the case of the first and second modifications to be described below.

The outflow opening 12A of the second embodiment has an airflow path defined by outflow wall surfaces 12Aw. Unlike the outflow wall surfaces 12w of the first embodiment, the outflow wall surfaces 12Aw extend along a direction S inclined at angle θ from the direction V perpendicular to a tangent to the curve of the outer edge of the magnetic disk 110, as illustrated in FIG. 6. Accordingly, the direction is inclined in which the air having passed through the circulation filter 13 is discharged into the space over the magnetic disk 110 from the outflow opening 12A. The inclination corresponds to the angle θ from the perpendicular direction V so that the inclined direction follows the direction of the rotational airflow over the magnetic disk 110. Such a shape of the outflow opening 12A prevents the air from flowing back to the circulation filter airflow path 14A from the open space over the magnetic disk 110 via the outflow opening 12A, as in the case of the outflow opening 12 of the first embodiment. As a result, it is possible to prevent an increase in the outlet pressure of the circulation filter. This, in turn, prevents a reduction in the flow rate through the circulation filter 13, thereby preventing a reduction in the dust trapping efficiency.

The following effects are expected according to the shapes of the circulation filter airflow paths 14 and 14A, the shapes of the inflow openings 11 and 11A and the shapes of the outflow opening 12 and 12A of the first and second embodiments, respectively. That is, a circulation airflow flowing in a direction opposite to the rotational airflow over the magnetic disk 110 is formed in the circulation filter airflow paths 14 and 14A without separately providing components, such as a flow rectifying plate and an inductive plate, over the magnetic disk 110 or between the magnetic disks 110. As a result, an increase in power consumption due to an increase in the workload of the spindle motor 120 caused by separately providing such components is never an issue for the first and second embodiments. In addition, according to the first and second embodiments, the formation of the circulation airflow flowing in the direction opposite to the rotational airflow over the magnetic disk 110 within the circulation filter airflow paths 14 and 14A produces the following effects. That is, the flow rate through the circulation filter 13 is effectively increased, whereby the dust trapping efficiency is improved.

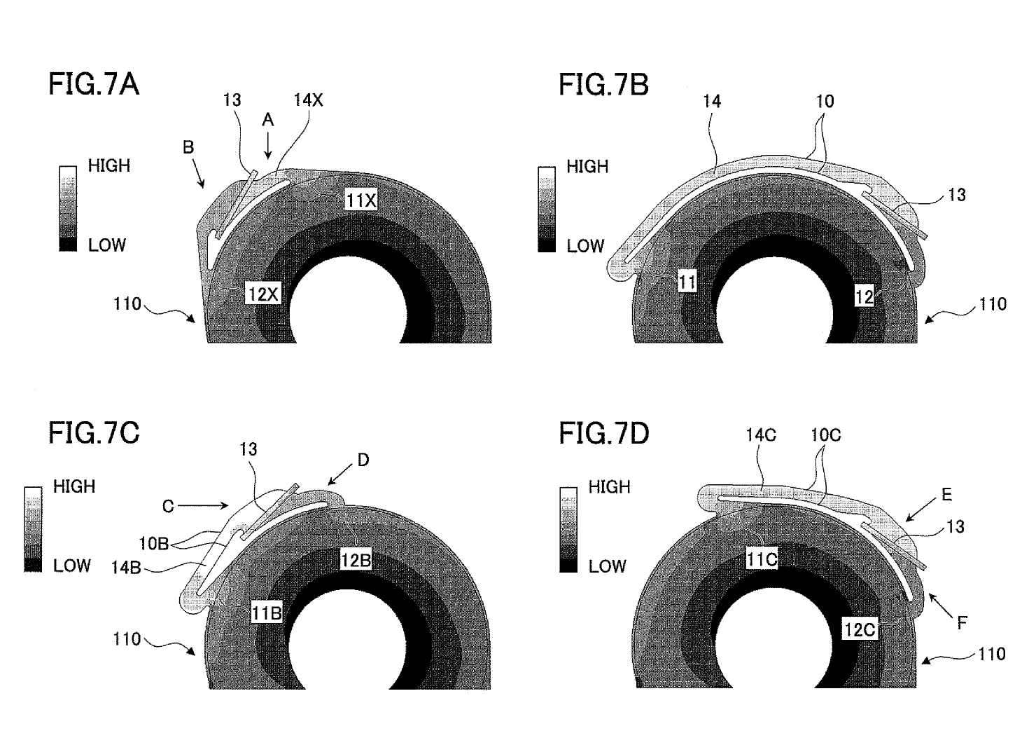

With reference to FIGS. 7 and 8, the following describes four types of structural examples (the above comparative example, the first embodiment, and first and second modifications of the first embodiment) in comparison to each other.

In order to facilitate understanding, within the rotational airflow over the magnetic disk 110 of FIG. 8, a range enclosed by a dotted line on the upper left side of the carriage arm 140 is referred to as “arm upstream”, and a range enclosed by a dotted line on the upper right side of the carriage arm 140 is referred to as “arm downstream”. The definition of these terms is consistent throughout the entire specification.

FIG. 7A relates to the comparative example; FIG. 7B relates to the first embodiment; and FIGS. 7C and 7D relate to the first and second modifications, respectively, of the first embodiment.

In the case of the hard disk device according to the first modification, an inflow opening 11B of a circulation filter airflow path 14B is located at the same position as that of the inflow opening 11 of the first embodiment. Note however that the position of an outflow opening 12B is shifted in the counterclockwise direction compared to the position of the outflow opening 12 of the first embodiment. Accordingly, the circulation filter airflow path 14B of the first modification has about the same length as the circulation filter airflow path of the comparative example. A simulation under the same conditions described with reference to FIG. 4 has been carried out with the first modification, and the first modification exhibits an increased flow rate through the circulation filter 13 by 13% compared to the comparative example.

In the case of the first modification of FIG. 7C, the inflow opening 11B is located at the same position as that of the outflow opening 12X of the comparative example of FIG. 7A, and the outflow opening 12B is located at the same position as that of the inflow opening 11X of the comparative example. However, unlike the comparative example, the first modification has the inflow opening 11B close to the arm upstream, whereby the rotational airflow once interfered with by the carriage arm 140 is able to sufficiently develop again by the time of reaching the inflow opening 11B. As a result, the stagnation pressure at the inlet (a position C in FIG. 7C) of the circulation filter 13 increases, and therefore, the pressure difference between the front side and the back side of the circulation filter 13 increases. That is, in FIGS. 7A and 7C, the pressures at positions A, B, C and D satisfy a relationship of C>A (the inflow sides of the circulation filters) and B≈D (the outflow sides of the circulation filters). Accordingly, the first modification has an increased flow rate through the circulation filter 13 compared to the comparative example, as mentioned above.

In the case of the second modification of FIG. 7D, an inflow opening 11C is located at the same position as that of the inflow opening 11X of the comparative example of FIG. 7A; however, an outflow opening 12C is located on the opposite side compared to the outflow opening 12X of the comparative example. A simulation under the same conditions described with reference to FIG. 4 has been carried out with the second modification, and the second modification exhibits an improved flow rate through the circulation filter 13 by 24% compared to the comparative example. Since the second modification has the inflow opening 11C at the same position as that of the inflow opening 11X of the comparative example, the stagnation pressures on the inflow sides of the circulation filters 13 (at the position A in FIG. 7A and at a position E in FIG. 7D) are approximately the same in both cases. However, unlike the comparative example, the second modification has the outflow opening 12C at the arm downstream in which the rotational airflow once interfered with by the carriage arm 140 has yet to be fully developed. Accordingly, the pressure around the outflow opening 12C (at a position F in FIG. 7D) is less than the pressure around the outflow opening 12X (at the position B in FIG. 7A) of the comparative example. Thus, in the second modification, the outlet pressure of the circulation filter 13 is reduced, and therefore, the pressure difference between the front side and the back side of the circulation filter 13 increases. That is, in FIGS. 7A and 7D, the pressures at the positions A, B, E and F satisfy a relationship of A≈E (the inflow sides of the circulation filters) and B>F (the outflow sides of the circulation filters). Accordingly, the second modification also has an increased flow rate through the circulation filter 13 compared to the comparative example, as mentioned above.

The following conclusions are drawn from the above analyses. That is, the increase in the flow rate through the circulation filter 13 (+34%) according to the first modification is almost equal to a simple addition of the increase in the flow rate through the circulation filter 13 (+13%) according to the first modification to the increase in the flow rate through the circulation filter 13 (+24%) according to the second modification. Namely, 13+24=37≈34. In conclusion, the inflow opening is preferably disposed, within the arm upstream where the rotational airflow over the magnetic disk 110 has been sufficiently developed, as close to the carriage arm 140 as possible. Also, the outflow opening is preferably disposed, within the arm downstream where the rotational airflow has yet to be developed, as close to the carriage arm 140 as possible.

According to the information storing apparatus described above, it is possible to increase the pressure difference between the inflow side and the outflow side of the circulation filter, thereby improving the filter efficiency, i.e. the dust trapping efficiency. In addition, in order to effectively improve the dust trapping efficiency, the information storing apparatus uses only a required minimum space for the airflow path which leads, to the circulation filter, the rotational airflow caused by the rotation of the memory medium.

The above embodiments and modifications are described with an example of a hard disk device using the magnetic disk 110. However, the present disclosure is not limited to this case and is applicable to other types of information storing apparatuses using rotating memory media.

All examples and conditional language used herein are intended for pedagogical purposes to aid the reader in understanding the present disclosure and the concepts contributed by the inventor to furthering the art, and are to be construed as being without limitation to such specifically recited examples and conditions, nor does the organization of such examples in the specification relate to a showing of the superiority or inferiority of the present disclosure. Although the embodiments of the present disclosure have been described in detail, it should be understood that various changes, substitutions, and alterations could be made hereto without departing from the spirit and scope of the present disclosure.

What is claimed is:

1. An information storing apparatus comprising:
a rotatably-mounted memory medium;
a carriage arm having, at a tip thereof, a head configured to perform at least one of reproduction of information recorded on the memory medium and writing of information on the memory medium, the carriage arm being movable so as to move the head to a predetermined position relative to the memory medium;
a flow rectifying wall disposed along an outer circumference of the memory medium, configured to lead a partial airflow which is part of a rotational airflow flowing in a rotation direction of the memory medium and rectify the partial airflow, and including an inflow opening from which the partial airflow flows into an inner path of the flow rectifying wall and an outflow opening from which the partial airflow having passed through the inner path of the flow rectifying wall flows out; and
a circulation filter;
wherein the inflow opening is disposed on an upstream side of the rotational airflow with respect to the carriage arm, and the outflow opening is disposed on a downstream side of the rotational airflow with respect to the carriage arm, and
the circulation filter is disposed in such a position that the partial airflow led into the inner path of the flow rectifying wall flows into the circulation filter in a direction opposite to a flow direction of the rotational airflow.

2. The information storing apparatus as claimed in claim 1, wherein the outflow opening has one of an airflow path oriented in a direction perpendicular to the flow direction of the rotational airflow and an airflow path inclined in such a manner that a direction in which the partial air flow flows out is inclined to a side of the flow direction of the rotational airflow.

3. The information storing apparatus as claimed in claim 1, wherein the inflow opening has an airflow path along a direction tangent to the flow direction of the rotational airflow.
